(19) United States
(12) Patent Application Publication
(10) Pub. No.: US 2003/0174263 A1
(43) Pub. Date: Sep. 18, 2003

(54) Reversible information carrying system that turns from invisible to readable

(76) Inventor: Nabil M. Lawandy, North Kingstown, RI (US)

Correspondence Address: HARRINGTON & SMITH, LLP, 4 RESEARCH DRIVE, SHELTON, CT, 06484-6212, US

(21) Appl. No.: 10/322,141

(22) Filed: Dec. 18, 2002

Related U.S. Application Data
(60) Provisional application No. 60/341,621, filed on Dec. 18, 2001.

(51) Int. Cl. G02F 1/1333

(52) U.S. Cl. 349/86

(57) ABSTRACT

Cholesteric liquid crystals in microencapsulated form are applied as a background or as printed information as a part of a reversible information carrying system. The reversible information system is normally invisible under ambient conditions, while providing a highly contrasting background to a dataform symbology upon stimulation with appropriate forms of at least one of heat and light. The reversible information system is adapted for the demands of automated sorting systems.

### CLAIM OF PRIORITY

This application claims priority under 35 U.S.C. §119(e) from U.S. Provisional Patent Application Serial No. 60/341,621, filed Dec. 18, 2001.

### TECHNICAL FIELD

These teachings relate generally to the use of thermotropic liquid crystals in reversibly contrasting information carrying systems.

### BACKGROUND

It is known that thermotropic liquid crystals respond to heat in a variety of ways. Certain cholesteric liquid crystals (sterol derived and non-sterol derived or mixtures of the two, herein referred to as CLC) change their helical pitch with temperature and diffract light at certain wavelengths, thereby changing their color as a function of temperature. This phenomenon is the basis of thermal sensing coatings and sheets such as those sold by Hallcrest Technologies.

In processes where a film is formed containing CLC materials, the CLC microcapsules are disbursed between laminating sheets or in a binder, respectively. Since the liquid crystal or mixture of liquid crystals only diffract light at a narrow range of wavelengths, the background on which they are viewed in white light must be black, or it must be a broadband absorber. A black background will absorb all wavelengths except the ones diffracted, thereby returning a specific color.

Examples of uses of liquid crystal materials are provided in U.S. Pat. No. 6,259,506 B1 “Field Activated Security Articles Including Polymer Dispersed Liquid Crystals, And Including Micro-Encapsulated Field Affected Materials” issued Jul. 10, 2001 to Lawandy. This patent discloses using polymer dispersed liquid crystals and micro-encapsulated liquid crystals with an orientable dye to provide security articles.

It is also known in the art to include isotropic dyes in an epoxy resin as well as liquid crystals when making optical shutters. The dye concentration can be adjusted to maximize the percent transmission through the film between the on and off states. High contrast, colored displays have been made using an isotropic dye containing PDLC films and complementary colored backgrounds. Reference in this regard can be made to a publication entitled “Polymer Dispersed Liquid Crystals Incorporating Isotropic Dyes”, SPIE Proceedings, 1080 (1989), J. L. West et al., and to a publication entitled “Characterization Of Polymer Dispersed Liquid-Crystal Shutters By Ultraviolet/Visible And Infrared Absorption Spectroscopy”, J. Appl. Phys. 70(7), Oct. 1, 1991, pgs. 3785-3790, J. L. West et al.

Turning to bar codes, and problems using bar codes, it has long been known that current bar coding techniques are ineffective in some applications, such as where highly contrasting systems are required for effective imaging. For example, reference may be had to U.S. Pat. No. 5,521,371 “Rewritable Bar Code Display Medium And Image Display Method And Image Display Apparatus Using The Same” issued May 28, 1996 to Hotta et al. This patent discloses a rewritable bar code display medium using a reversible thermosensitive recording layer, and apparatus for implementation.

Additionally, some coding applications require more data than is practicably contained in current systems. Therefore, what is needed is a technique to overcome the limitations encountered by current coding applications.

### SUMMARY OF THE INVENTION

The foregoing and other problems are overcome, and other advantages are realized, in accordance with the presently preferred embodiments of these teachings.

In one embodiment, cholesteric liquid crystals (CLC) in microencapsulated form are disbursed in a binder. The CLC are applied as a coating over a thermochromic or photochromic background, where the background changes from clear (substantially transparent) to black, dark blue or a suitable equivalent. A substantially transparent coating may then be applied over the cholesteric microcapsules. The same or a similar material used for the background is then printed on top of the substantially transparent coating to record information. At ambient temperature, the background, the CLC coating and the printed information are transparent at visible wavelengths. When the system is stimulated with heat or heat and light (for the print or background) the system exhibits high contrast at the wavelength where the CLC is tuned, allowing for the reading of information such as a datacode symbology (e.g., a bar code).

In another embodiment, CLC in microencapsulated form are applied as printed information over a thermochromic or photochromic background, where the background changes from substantially transparent to black, dark blue or a suitable equivalent. At ambient temperature, the background and the printed information are transparent at visible wavelengths. When the system is appropriately stimulated, the system exhibits high contrast at the wavelength where the CLC is tuned, allowing for the reading of information such as a datacode symbology (e.g., a bar code).

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 illustrates an application of printed information using a thermochromic ink formed of cholesteric liquid crystals in microencapsulated form over a thermochromic or photochromic primer that is applied over a substrate;

FIG. 2 illustrates an application of printed information over a substantially transparent background applied over a coating of thermochromic ink formed of cholesteric liquid crystals in a microencapsulated form lying on top of a thermochromic or photochromic background;

FIG. 3 illustrates an application of multiple layers of printed information using a thermochromic ink formed of cholesteric liquid crystals in microencapsulated form over a thermochromic or photochromic primer;

FIG. 4 shows, in block diagram form, a method for application of the layer of primer and the CLC printing of indicia to a plurality of mail pieces; and,

FIG. 5 shows, in block diagram form, a method for imaging the CLC printing of indicia, and using the information obtained from the imaging process for sorting purposes.

### DETAILED DESCRIPTION THE INVENTION

This invention employs selected materials to provide for an invisible or unobtrusive marking system wherein a marking does not obscure underlying and/or surrounding information under ambient environmental conditions, while the marking system provides a degree of marking quality necessary to permit use of optical imaging systems for reliable interpretation of the marking.

It should be realized that the teachings of this invention could be employed to mark and subsequently identify one to many articles. This system can therefore be used in a wide variety of applications ranging from instances where invisible or unobtrusive markings may be read on an infrequent basis, to large scale sorting applications and other similar processes. For example, the marking system disclosed herein may be used to mark and identify items in a mail sorting application, where high volume sorting abilities and therefore quality markings are required.

These teachings of this invention are not, however, limited for use with mailing systems, but can be applied in a number of different types of application, including, as non-limiting examples, the marking and sorting of bank checks and the marking and/or sorting of manufactured items. Thus, while the teachings of this invention will be described below primarily in the context of the marking, identification and sorting of mail pieces, those skilled in the art should recognize that the teachings of this invention can be employed in a large number of identification and sorting applications.

In one embodiment of the present invention, cholesteric liquid crystals (CLC) are microencapsulated to form, for example, a powder. The powder containing microcapsules is intermixed with a binder or carrier suitable for application to a substrate. For example, the binder or carrier may be used to form a film, an ink, or paint.

The microencapsulation of the CLC can be accomplished in accordance with, by example, procedures disclosed in U.S. Pat. No. 3,956,172, issued May 11, 1976, entitled “Process For Hardening Microcapsules Containing Hydrophobic Oil Droplets”, by Saeki et al., U.S. Pat. No. 4,808,408, issued Feb. 28, 1989, entitled “Microcapsules Prepared By Coacervation”, by Baker et al., U.S. Pat. No. 5,053,277, issued Oct. 1, 1991, entitled “Microcapsules And Their Production”, by Vassiliades, U.S. Pat. No. 5,397,624, issued Mar. 14, 1995, entitled “Pressure-Sensitive Copying Paper”, by Moyaerts et al. In accordance with the present invention, the microcapsules are of a diameter in the range of about two micrometers to some hundreds of micrometers.

Thus, according to the microencapsulation technique taught by Baker et al. (U.S. Pat. No. 4,808,408) microencapsulation of the core ingredient of CLC may be completed by, for example, (1) mixing a coacervation adjuvant with the core ingredient, (2) emulsifying the mixture in an aqueous solution of an ionizable colloid, (3) combining, while agitating, the emulsion of step (2) with an aqueous solution of a second ionizable colloid of opposite electrical charge to that of the first colloid, (4) cooling the mixture to cause gelation of capsule walls, (5) adding a water soluble wax derivative to stabilize the gelled capsules and to prevent agglomeration, and (6) hardening the capsule walls. When the above steps are completed the microcapsules are dried to form the powder which is subsequently intermixed with the suitable binder or carrier to provide the desired form for application to a substrate.

FIG. 1 shows a material that turns black or blue with an external stimulus (such as and not limited to thermal energy or wavelengths of light). The material is applied as a primer layer 2 over a substrate 3 (such as a piece of mail, or a document, or any type of suitable substrate). Printed information 1 is laid over the primer layer 2 with a form of the CLC which, when stimulated, diffracts light at a wavelength where a detecting system is sensitive, such as a scanning or imaging bar code reader. In this embodiment, the printed information 1 is illuminated with white light 11, and diffracts the white light 11 at a specific wavelength 12.

The cholesteric liquid crystals (CLC) may be sterol derived, non-sterol derived, or a mixture of the two. The CLC are microencapsulated in a flexible film, or in a binder which provides for application as a paint or ink. In some embodiments, the CLC are thermochromic. In other embodiments, the CLC are photochromic. In further embodiments, the CLC are thermochromic and photochromic. In some further embodiments, the CLC are responsive to stress, shear or pressure.

CLC may be selected for practice of this invention on the basis of various factors. For example, CLC may be selected on bases that include, and are not limited to cost, availability, and diffraction wavelength. As used herein, the term “tuned” refers to the selection of a particular CLC on the basis of the diffraction wavelength. That is, a CLC may be “tuned” to a wavelength that matches optimal sensitivity of an imaging system that is to be used to image CLC based markings. Optimal performance for an imaging system might have users select a CLC ink to diffract at 500-550 nm where detector/window combinations give maximum response. As another example, a CLC operating at 45° C. could be tuned to about 650 nm, where commonly used scanners operate.

The term “substrate 3” embraces any article or object suited for marking with a datacode symbology, such as a bar code. Substrates 3 therefore include, and are not limited to, articles or objects for marking, or an intermediate transfer mechanism, such as a label. That is, any surface that is supportive of receipt of a structure as disclosed herein may be used as a substrate 3.

The invention disclosed herein provides certain advantages in that the primer layer 2 provides for a uniform background to the printed information 1. Therefore, the substrate 3 are not limited by their appearance, in that emission wavelengths associated with multiple colors or other features which may typically defeat a code reading device are effectively blocked by the primer layer 2 during the imaging process.

Printing of CLC ink can be accomplished in a variety of ways, including but not limited to using flexo, intaglio, inkjet, or thermal transfer. Likewise, the curing of CLC ink can be accomplished in a variety of ways, including but not limited to exposure to air, heat, or exposure to ultraviolet light.

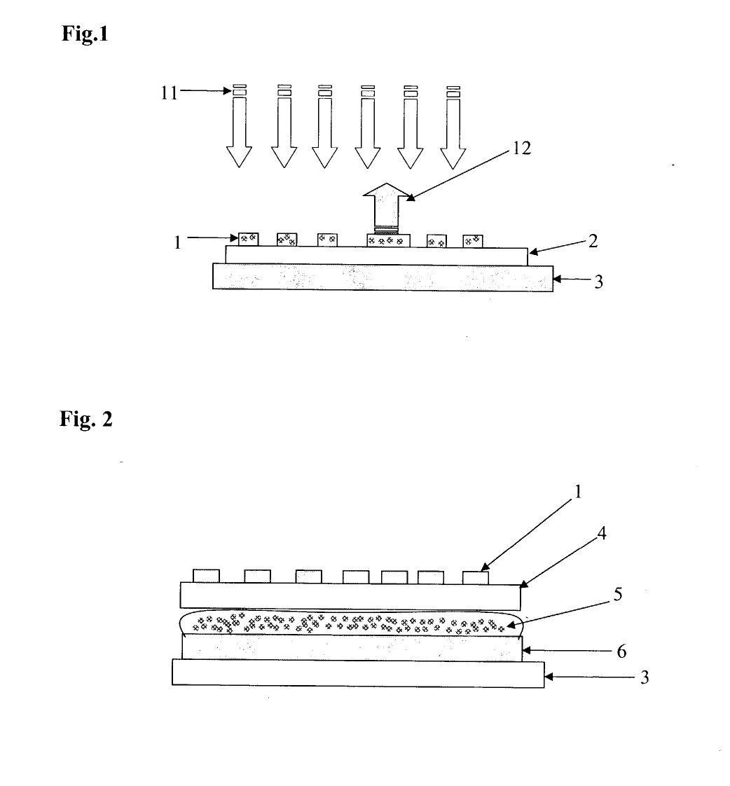

FIG. 2 shows an application where CLC microcapsules in a binder are applied as a coating 5 over a background 6 that contains at least one of thermochromic materials and photochromic materials. The background 6 changes from a substantially transparent state, also referred to as “clear”, to black, dark blue, or a suitably absorbent equivalent when stimulated, and thus becomes contrasting with the printed information 1.

The binder that is used for the CLC microcapsules can be composed of, and is not limited to, water based or solvent based polymers cured by heat, moisture or light. A substantially transparent coating or surface 4 is then applied over the CLC microcapsules coating 5. The same material used for the background can be used to print information 1 on top of the substantially transparent coating 4. The material of the printing 1 goes from being substantially transparent to black or some other absorbent color at the diffracted wavelength of the CLC microcapsule coating 5, and thus exhibits a high degree of contrast with the coating 5. At ambient temperatures (i.e., normal room temperature and generally accepted ranges thereof), the CLC microcapsule coating 5 is transparent, or substantially transparent, at visible wavelengths and the background 6 and the printed information 1 are also transparent, or substantially transparent. When the system is stimulated with heat or heat and light (for the print or background) the system exhibits a high degree of contrast at the wavelength where the CLC is tuned, allowing for the reliable reading of printed information 1 such as a symbology or a bar code through appropriate means.

The printed information 1 may contain any one or more of a number of different information schemes. For example, the printed information 1 may include, without limitation, any suitable type of bar code, alphanumeric character(s), geometric or other codes, graphics, or other form providing a suitable dataform symbology.

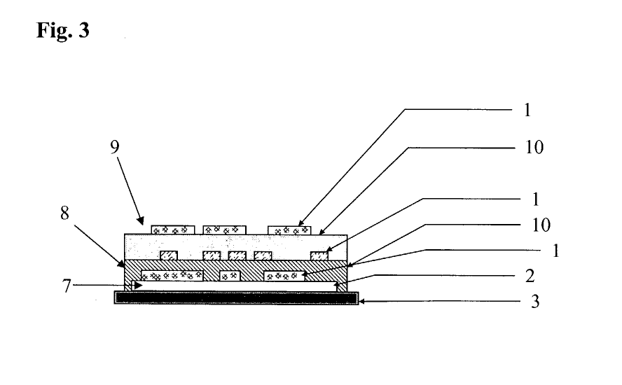

FIG. 3 shows an application where multiple layers of this invention are used. In this application, the several layers 7, 8, 9 of the CLC microcapsules are unique to each other in that each layer is diffractive at a different wavelength or temperature.

In this arrangement, if one layer is diffracting at wavelength λₐ at T₁ and the others are at wavelengths λ_{b} and λ_{c} while also at T₁, then different layers of information can be read. This may be accomplished by methods that include but are not limited to filtering at the sensor or imager, either by scanning at different wavelengths λ, by filtering the light to the imager or by using a color imager and electronically separating the pixel returns.

Alternatively, a fixed detection wavelength band is used and the CLC information layers 1 are scanned through the readout band by ramping the temperature. This technique allows a conventional scanner to be used. For example, if 635 nm or 650 nm was used, the first CLC ink in the first layer 7 would be “red” diffracting at T₁, the CLC ink in the second layer 8 printed above it, would be at red at T₂, and CLC ink in the third layer 9 would be red at T₃. The sensor performs multiple scans to acquire all layers of information as the temperature is ramped. In this embodiment, the coating applied over the secondary applications 10 could be thermochromic and designed to change with the change in the CLC ink, or substantially transparent depending upon the needs of the user.

By controlling aspects of the marking disclosed herein, one is able to adapt the marking for machine decoding. That is, the marking may be designed for optimal performance of an imaging or scanning system, by controlling aspects such as, and not limited to, diffraction wavelength, the size of the marking, threshold temperatures for phase changes, duration of phase changes of the photochromic and/or thermochromic materials, wavelength or temperature separation of materials used, form of the marking, and content of the marking.

Using the three dimensional layered approach illustrated in FIG. 3 allows users to store and retrieve more information that can be stored by a two dimensional system. In addition, digital watermarking can be employed in at least one of the printed information 1 and the background 6. Digital watermarking may be used on all or certain layers to hide information and/or to further increase the information content of the marking. A suitable, and non-limiting digital watermarking technique is disclosed in U.S. Pat. No. 6,243,480 “Digital Authentication With Analog Documents” issued Jun. 5, 2001 by Zhao et al., which is incorporated herein by reference in its entirety.

### Exemplary Applications

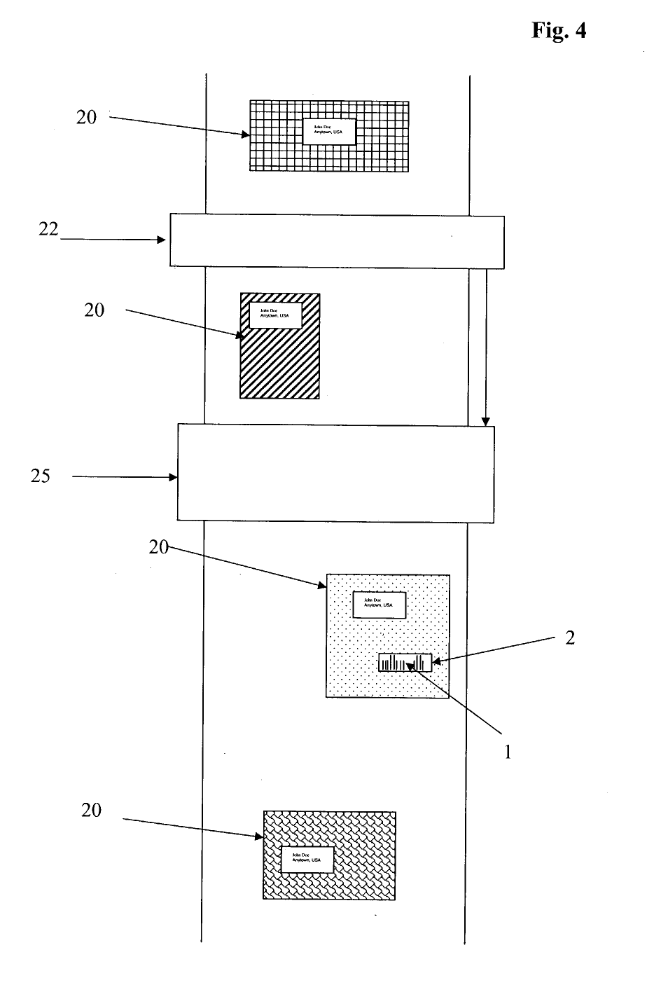

FIG. 4 shows how this invention can be used in an exemplary mail sorting application. FIG. 4 depicts an embodiment where a plurality of substrate mail pieces 20 require marking. Note that the mail pieces 20 may have various background patterns as well as colors. In this embodiment of a mail sorting application, the address of each mail piece 20 is scanned by an optical character recognition (OCR) imaging device 22 which interprets address information for subsequent encoding. This information is used to generate a sort code that is of an appropriate form for the type of sort coding system in use. Once the information needed for encoding CLC printing or indicia 1 has been determined, the information is routed to a layer and indicia application device 25 that applies a primer layer 2 and printed information 1 to the substrate mail piece 20. The printed information 1 carries appropriate sort code information for the mail piece 20. (Note that in FIG. 4, the primer layer 2 and the CLC printing 1 are shown for demonstration purposes only, and that in reality they would not be visible until subjected to an appropriate stimulus). The mail pieces 20 continue through the production line where the mail pieces 20 are aggregated for subsequent handling. In this embodiment, both the primer layer 2 and the printed information 1 are normally invisible, or substantially invisible, on the surface of the mail piece 20, and thus do not interfere with the viewing of the background pattern on the mail piece 20. In another embodiment, only the primer layer 2 is transparent or substantially transparent.

In another embodiment, the OCR imaging device 22 is omitted, and address information is manually read by personnel, who subsequently apply an appropriate primer layer 2 and printed information 1. The application of the appropriate primer layer 2 and printed information 1 may involve various steps, including and not limited to, encoding of the printed information 1, data entry into an application device for automated production and/or application of sort code information, segregation of mail pieces 20 for subsequent application of the primer layer 2 and printed information 1, and/or manual production and affixation of the primer layer 2 and printed information 1 to the mail piece 20.

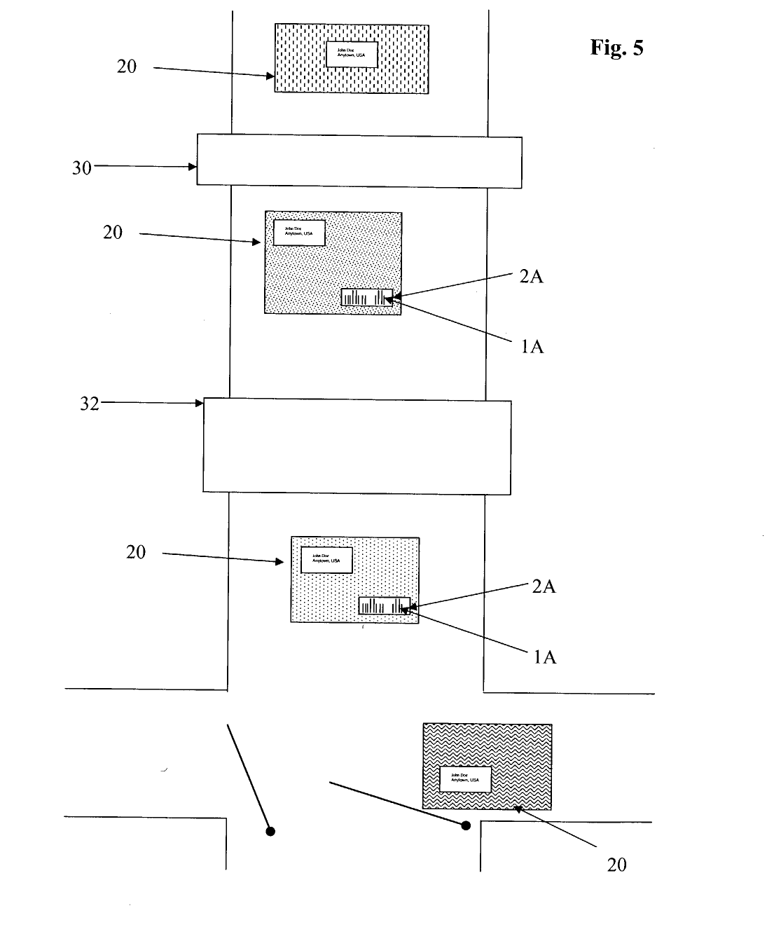

FIG. 5 shows one embodiment of a second stage of the mail sorting application. In this embodiment, the mail pieces 20 coded with the layer of primer 2 and the CLC printing 1 are loaded into a production line wherein each mail piece 20 is subjected to a stimulus by a stimulus application device 30, wherein the stimulus applied to each mail piece 20 is appropriately delivered for initiation and completion of a phase change in the primer layer 2 and the printed information 1. Note that after stimulation, such as by thermally stimulating the primer layer 2 above the required threshold for visible changes, the primer layer 2 becomes visible as primer layer 2A, and forms a contrasting background for the printed information 1A. Before the primer layer 2A and printed information 1A have acclimated to normal environmental conditions, the printed information 1A is read and decoded using an appropriate indicia reading and decoding device 32, such as a bar code scanner, or an imaging device with OCR and/or pattern recognition software, depending on the nature of the printed information 1A. Information derived from the printed information 1A is then used to fulfill the requirements of subsequent sorting applications, which can also include applying another primer layer 2 and printed information 1 to the mail piece 20, such as one required to decode down to the carrier route level. Note in FIG. 5 that by the time the mail pieces 20 have reached the sorting equipment of a sort path, the primer layer 2A may have cooled to the point that it crosses through the threshold for a change in physical appearance, and the primer layer 2A has once again become transparent or substantially transparent, thereby removing the visually contrasting background from beneath and around the printed information 1.

Other applications for and embodiments of this invention may occur to those skilled in the art when guided by these teachings, and thus these further applications and embodiments will all fall within the scope of this invention.

What is claimed is:

1. A structure for carrying information comprised of:
a layer of thermotropic liquid crystals in a microencapsulated form applied over a background comprising at least one of thermochromic material and photochromic material; and
printed information deposited over the layer.

2. A structure as in claim 1, wherein the layer comprises at least one of sterol derived cholesteric liquid crystals and non-sterol derived cholesteric liquid crystals.

3. A structure as in claim 1, wherein the thermotropic liquid crystals are incorporated into a carrier, the carrier comprising one of a flexible film and a binder adapted for application as an ink or paint.

4. A structure as in claim 1, wherein the thermotropic liquid crystals diffract light at wavelengths comprising about 650 nm.

5. A structure as in claim 1, wherein the thermotropic liquid crystals diffract light at wavelengths comprising between about 500 nm to about 550 nm.

6. A structure as in claim 1, wherein the thermotropic liquid crystals diffract light at wavelengths comprising wavelengths of about the optimal sensitivity of an imaging system.

7. A structure as in claim 1, wherein the color of the background changes, when stimulated, to a color that contrasts with the printed information.

8. A structure as in claim 1, wherein the background when stimulated becomes absorbent at wavelengths diffracted by the thermotropic liquid crystals.

9. A structure as in claim 1, wherein the printed information comprises at least one of a bar code, alphanumeric characters, a geometric code, and graphics.

10. A structure as in claim 1, further comprising a substantially transparent coating disposed over the layer of thermotropic liquid crystals.

11. A structure as in claim 10, wherein the printed information is formed of a material that comprises the at least one of thermochromic material and photochromic material comprising the background.

12. A structure as in claim 1, wherein at ambient temperatures, at least one of the background and the layer is substantially transparent at visible wavelengths.

13. A structure as in claim 10, wherein the structure is adapted for decoding by at least one of scanning or imaging.

14. A method for labeling a substrate with printed information comprising:
applying a background comprising at least one of thermochromic material and photochromic material over the substrate;
applying a layer of thermotropic liquid crystals in a microencapsulated form over the background; and,
printing information over the layer.

15. A method as in claim 14, wherein the layer is applied as at least one of a flexible film, as an ink, or as a paint.

16. A method as in claim 14, wherein the layer is cured by methods comprising at least one of air drying, heating and exposure to ultraviolet light.

17. A method as in claim 14, wherein at ambient temperatures, at least one of the layer and the background are substantially transparent at visible wavelengths.

18. A method as in claim 14, wherein the printed information exhibits a high degree of contrast with the background when stimulated with at least one of light and heat.

19. A method as in claim 14, further comprising applying a substantially transparent coating over the layer and before printing the information.

20. An apparatus for carrying information wherein the apparatus is comprised of:
a background comprising at least one of thermochromic material and photochromic material; and thermotropic liquid crystals in a microencapsulated form deposited over the background as printed information.

21. An apparatus as in claim 20, wherein the thermotropic liquid crystals comprise at least one of sterol derived cholesteric liquid crystals and non-sterol derived cholesteric liquid crystals.

22. An apparatus as in claim 20, wherein the microencapsulated form is incorporated into a carrier, the carrier comprising a flexible film or a binder adapted for application as an ink or paint.

23. An apparatus as in claim 20, wherein the thermotropic liquid crystals diffract light at wavelengths comprising about 650 nm.

24. An apparatus as in claim 20, wherein the thermotropic liquid crystals diffract light at wavelengths comprising between about 500 nm to about 550 nm.

25. An apparatus as in claim 20, wherein the thermotropic liquid crystals diffract light at wavelengths comprising wavelengths of about the optimal sensitivity of an imaging system.

26. An apparatus as in claim 20, wherein the color of the background changes when stimulated to a color that comprises at least one of black or dark blue.

27. An apparatus as in claim 20, wherein the background when stimulated becomes absorbent at wavelengths diffracted by the thermotropic liquid crystals.

28. An apparatus as in claim 20, wherein the printed information comprises at least one of a bar code, alphanumeric characters, a geometric code, and graphics.

29. A structure as in claim 20, wherein the structure is adapted for decoding by at least one of scanning and imaging.

30. A method for labeling a substrate with printed information wherein:
applying a background comprising at least one of thermochromic material and photochromic material over the substrate; and,
depositing thermotropic liquid crystals in a microencapsulated form over the background as printed information.

31. A method as in claim 30, wherein the depositing comprises at least one of flexo, intaglio, inkjet and thermal transfer.

32. A method as in claim 30, wherein the thermotropic liquid crystals are cured by methods comprising at least one of air drying, heating and exposure to ultraviolet light.

33. A method as in claim 30, wherein at ambient temperatures, at least one of the thermotropic liquid crystals and the background are substantially transparent at visible wavelengths.

34. A method as in claim 30, wherein the printed information exhibits high contrast with the background when stimulated with at least one of light and heat.

35. A marking for carrying information comprising:
a first structure comprising a background comprising at least one of thermochromic material and photochromic material; and thermotropic liquid crystals in a microencapsulated form deposited over the background as printed information;
at least one secondary structure applied over the first structure, the secondary structure comprising a background comprising at least one of thermochromic material and photochromic material; and thermotropic liquid crystals in a microencapsulated form deposited over the background as printed information.

36. A marking as in claim 35, wherein the first structure and the at least one secondary structure diffract a specific wavelength at differing temperatures.

37. A marking as in claim 35, wherein the first structure and the at least one secondary structure diffract a differing wavelengths at a specific temperature.

38. A method for marking a mail piece, comprising:
providing a mail piece requiring marking;
identifying an address to which the mail piece is to be delivered;
encoding address information for the mail piece;
forming a marking on the mail piece, the marking carrying the encoded address information and comprising at least a layer of a background comprising at least one of thermochromic material and photochromic material, the layer supporting microencapsulated thermotropic liquid crystals, the layer reversibly becoming highly contrasting to the thermotropic liquid crystals upon stimulation.

39. A method for sorting a mail piece, comprising:
providing a mail piece for sorting, the mail piece having been marked with a marking comprising at least a layer of a background comprising at least one of thermochromic material and photochromic material, the marking formed onto the mail piece, and the layer supporting an application of thermotropic liquid crystals; wherein the marking carries encoded address information;
subjecting the layer and application of thermotropic liquid crystals to stimulus comprising at least one of heat and light to create optical changes in the appearance of the marking;
detecting information recorded in the marking;
interpreting information recorded in the marking; and
providing the information to a mail sorting system.
